(19) United States
(12) Patent Application Publication
(10) Pub. No.: US 2022/0134292 A1
(43) Pub. Date: May 5, 2022

(54) IONICALLY CONDUCTIVE THIN FILM COMPOSITE MEMBRANES FOR ENERGY STORAGE APPLICATIONS

(71) Applicant: UOP LLC, Des Plaines, IL (US)

(72) Inventors: Chunqing Liu, Arlington Heights, IL (US); Xueliang Dong, Schaumburg, IL (US); Chaoyi Ba, Schaumburg, IL (US)

(21) Appl. No.: 17/389,032

(22) Filed: Jul. 29, 2021

Related U.S. Application Data
(60) Provisional application No. 63/109,683, filed on Nov. 4, 2020.

(51) Int. Cl. B01D 69/12; H01M 50/449; H01M 8/18; H01M 50/491; H01M 50/497; H01M 50/414; B01D 69/10; B01D 71/08; B01D 71/38

(52) U.S. Cl. CPC B01D 69/125; H01M 50/449; H01M 8/18; H01M 50/491; H01M 50/497; H01M 50/414; B01D 2323/30; B01D 71/08; B01D 71/38; B01D 2325/02; B01D 2325/04; B01D 2325/26; B01D 2325/42; B01D 69/10

(57) ABSTRACT

An ionically conductive thin film composite (TFC) membrane is described. The low cost, high performance TFC membrane comprises a micropous support membrane, and a hydrophilic ionomeric polymer coating layer on a surface of the microporous support membrane. The hydrophilic ionomeric polymer coating layer is ionically conductive. The ionomeric polymer can also be present in the micropores of the support membrane. Methods of making the membrane and redox flow battery system incorporating the TFC membrane are also described.

### RELATED APPLICATIONS

This application claims the benefit of U.S. Provisional Patent Application Ser. No. 63/109,683 filed Nov. 4, 2020, the entirety of which is incorporated herein by reference.

### BACKGROUND OF THE INVENTION

Energy storage systems have played a key role in harvesting energy from various sources. The energy storage systems can be used to store energy and convert it for use in many different applications, such as building, transportation, utility, and industry. A variety of energy storage systems have been used commercially, and new systems are currently being developed. Energy storage types can be categorized as electrochemical and battery, thermal, thermochemical, flywheel, compressed air, pumped hydropower, magnetic, biological, chemical and hydrogen energy storages. The development of cost-effective and eco-friendly energy storage systems is needed to solve energy crisis and to overcome the mismatch between generation and end use.

Renewable energy sources, such as wind and solar power, have transient characteristics, which require energy storage. Renewable energy storage systems such as redox flow batteries (RFBs) have attracted significant attention for electricity grid, electric vehicles, and other large-scale stationary applications. RFB is an electrochemical energy storage system that reversibly converts chemical energy directly to electricity. The conversion of electricity via water electrolysis into hydrogen as an energy carrier without generation of carbon monoxide or dioxide as byproducts enables a coupling of the electricity, chemical, mobility, and heating sectors. Water electrolysis produces high quality hydrogen by electrochemical splitting of water into hydrogen and oxygen. Water electrolysis has zero carbon footprint when the process is operated by renewable power sources, such as wind, solar, or geothermal energy. The main water electrolysis technologies include alkaline electrolysis, polymer electrolyte membrane (PEM) electrolysis, and solid oxide electrolysis. PEM water electrolysis is one of the favorable methods for conversion of renewable energy to high purity hydrogen with the advantages of compact design, high current density, high efficiency, fast response, small footprint, lower temperature (20-90° C.) operation, and high purity oxygen byproduct.

RFBs are composed of two tanks filled with active materials comprising metal ions that may be in different valance states, two circulation pumps, and a flow cell with a separation membrane. The separation membrane is located between the anode and the cathode and is used to separate the anolyte and the catholyte, as well as to utilize the current circuit by allowing the transfer of balancing ions. Among all the redox flow batteries developed to date, all vanadium redox flow batteries (VRFB) have been the most extensively studied. VRFB uses the same vanadium element in both half cells which prevents crossover contamination of electrolytes from one half cell to the other half cell. VRFB, however, is inherently expensive due to the use of high cost vanadium and an expensive membrane. All-iron redox flow batteries (IFB) are particularly attractive for grid scale storage applications due to the use of low cost iron, salt, and water as the electrolyte.

The membrane is one of the key materials that make up a battery or electrolysis cell as a key driver for safety and performance. Some important properties for membranes for flow batteries, fuel cells, and membrane electrolysis include high conductivity, high ionic permeability (porosity, pore size and pore size distribution), high ionic exchange capacity (for ion-exchange membrane), high ionic/electrolyte selectivity (low permeability/crossover to electrolytes), low price (less than $150-200/m²), low area resistance to minimize efficiency loss resulting from ohmic polarization, high resistance to oxidizing and reducing conditions, chemically inert to a wide pH range, high thermal stability together with high proton conductivity (greater than or equal to 120° C. for fuel cell), high proton conductivity at high T without H₂O, high proton conductivity at high T with maintained high RH, and high mechanical strength (thickness, low swelling).

The two main types of membranes for redox flow battery, fuel cell, and electrolysis applications are polymeric ion-exchange membranes and microporous separators. The polymeric ion-exchange membranes can be cation-exchange membranes comprising —SO₃⁻, —COO⁻, —PO₃H²⁻, —PO₃H⁻, or —C₆H₄O⁻ cation exchange functional groups, anion-exchange membranes comprising —NH₃⁺, —NRH₂⁺, —NR₂H⁺, —NR₃⁺, or —SR₂⁻ anion exchange functional groups, or bipolar membranes comprising both cation-exchange and anion-exchange polymers. The polymers for the preparation of ion-exchange membranes can be perfluorinated ionomers such as Nafion®, Flemion®, and NEOSEPTA®-F, partially fluorinated polymers, non-fluorinated hydrocarbon polymers, non-fluorinated polymers with aromatic backbone, or acid-base blends. In general, perfluorosulfonic acid (PFSA)-based membranes, such as Nafion® and Flemion®, are used in vanadium redox flow battery (VRFB) systems due to their oxidation stability, good ion conductivity, unique morphology, mechanical strength, and high electrochemical performance. However, these membranes have low balancing ions/electrolyte metal ion selectivity, and high electrolyte metal ion crossover which causes capacity decay in VRFBs, and they are expensive.

The microporous and nanoporous membrane separators can be inert microporous/nanoporous polymeric membrane separators, inert non-woven porous films, or polymer/inorganic material coated/impregnated separators. The inert microporous/nanoporous polymeric membrane separators can be microporous polyethylene (PE), polypropylene (PP), PE/PP, or composite inorganic/PE/PP membrane, inert non-woven porous films, non-woven PE, PP, polyamide (PA), polytetrafluoroethylene (PTFE), polyvinyl chloride (PVC), polyvinylidene fluoride (PVDF), polyethylene terephalate (PET), or polyester porous film. For example, microporous Daramic® and Celgard® membrane separators made from PE or PP polymer are commercially available. They normally have high ionic conductivity, but also high electrolyte cross-over for RFB applications.

Despite the significant research efforts, the wide adoption of redox flow batteries for grid energy storage applications is still a challenge.

Therefore, there is a need for a reliable, high-performance (low electrolyte or gas crossover and excellent conductivity), low-cost membrane for energy storage applications such as redox flow battery, fuel cell, and electrolysis applications.

### DESCRIPTION OF THE INVENTION

This invention relates to a new type of low cost high performance ionically conductive thin film composite (TFC) membrane, and more particularly to a new low cost high performance hydrophilic ionomeric polymer coated TFC membrane for energy storage applications such as redox flow battery, fuel cell, and electrolysis applications. Other aspects include methods of making the membrane, and a redox flow battery system incorporating the TFC membrane.

The low cost high performance TFC membranes provide a new type of ionically conductive membrane that combines a size-exclusion ion-conducting separation mechanism derived from the hydrophilic property of the polymer with an ion-exchange ion-conducting separation mechanism derived from the ionomeric property of the polymer. The ionically conductive TFC membrane exhibits improved performance compared to traditional polymeric ion-exchange membranes with ion-exchange ion-conducting separation mechanism and microporous membrane separators with size-exclusion ion-conducting separation mechanism.

The new low cost high performance TFC membrane for redox flow battery, fuel cell, and electrolysis applications comprises a micropous support membrane, and a hydrophilic ionomeric polymer coating layer on a surface of the microporous support membrane. The ionomeric polymer can also be present in the micropores of the support membrane. The hydrophilic ionomeric polymer coating layer is ionically conductive, which means the hydrophilic ionomeric polymer coating layer has ionic conductivity and can transport the charge-carrying ions, such as protons or chloride ion (Cl⁻), from one side of the membrane to the other side of the membrane to maintain the electric circuit. The electrical balance is achieved by the transport of charge-carrying ions (such as protons, chloride ions, potassium ions, or sodium ions in all iron redox flow battery system) in the electrolytes across a membrane comprising a hydrophilic ionomeric polymer coating layer during the operation of the battery cell. The ionic conductivity (σ) of the membrane is a measure of its ability to conduct charge-carrying ions, and the measurement unit for conductivity is Siemens per meter (S/m). The ionic conductivity (σ) of the ionically conductive TFC membrane is measured by determining the resistance (R) of the membrane between two electrodes separated by a fixed distance. The resistance is determined by electrochemical impedance spectroscopy (EIS) and the measurement unit for the resistance is Ohm (Ω). The membrane area specific resistance (RA) is the product of the resistance of the membrane (R) and the membrane active area (A) and the measurement unit for the membrane area specific resistance is (Ω·cm²). The membrane ionic conductivity (σ, S/cm) is proportional to the membrane thickness (L, cm) and inversely proportional to the membrane area specific resistance (RA, Ω·cm²). The performance of the ionically conductive TFC membrane for RFB applications is evaluated by several parameters including membrane solubility and stability in the electrolytes, area specific resistance, numbers of battery charge/discharge cycling, electrolyte crossover through the membrane, voltage efficiency (VE), coulombic efficiency (CE), and energy efficiency (EE) of the RFB cell. CE is the ratio of a cell's discharge capacity divided by its charge capacity. A higher CE, indicating a lower capacity loss, is mainly due to the lower rate of crossover of electrolyte ions, such as ferric and ferrous ions, in the iron redox flow battery system. VE is defined as the ratio of a cell's mean discharge voltage divided by its mean charge voltage (See M. Skyllas-Kazacos, C. Menictas, and T. Lim, Chapter 12 on Redox Flow Batteries for Medium- to Large-Scale Energy Storage in Electricity Transmission, Distribution and Storage Systems. A volume in Woodhead Publishing Series in Energy, 2013). A higher VE, indicating a higher ionic conductivity, is mainly due to the low area specific resistance of the membrane. EE is the product of VE and CE and is an indicator of energy loss in charge-discharge processes. EE is a key parameter to evaluate an energy storage system.

The incorporation of the low cost high performance hydrophilic ionomeric polymer into the new TFC membrane provided a new type of ionically conductive membrane that combined a size-exclusion ion-conducting separation mechanism derived from the hydrophilic property of the polymer with an ion-exchange ion-conducting separation mechanism derived from the ionomeric property of the polymer. Therefore, the ionically conductive TFC membrane exhibited improved performance compared to traditional polymeric ion-exchange membranes with ion-exchange ion-conducting separation mechanism and microporous membrane separators with size-exclusion ion-conducting separation mechanism for energy storage applications such as for redox flow battery applications. The ionically conductive TFC membrane showed excellent membrane stability in the electrolytes, low area specific resistance, high numbers of battery charge/discharge cycles, low electrolyte crossover through the membrane, high VE, CE, and EE for redox flow battery applications.

The hydrophilic ionomeric polymer on the ionically conductive TFC membrane comprises a hydrophilic ionomeric polymer or a cross-linked hydrophilic ionomeric polymer comprising repeat units of both electrically neutral repeating units and a fraction of ionized functional groups such as —SO₃⁻, —COO⁻, —PO₃²⁻, —PO₃H⁻, —C₆H₄O⁻, —O₄B⁻, —NH₃⁺, —NRH₂⁺, —NR₂H⁺, —NR₃⁺, or —SR₂⁻. The hydrophilic ionomeric polymer contains high water affinity polar or charged functional groups such as —SO₃⁻, —COO⁻ or —NH₃⁺ group. The cross-linked hydrophilic polymer comprises a hydrophilic polymer complexed with a complexing agent such as polyphosphoric acid, boric acid, a metal ion, or a mixture thereof. The hydrophilic ionomeric polymer not only has high stability in an aqueous electrolyte solution due to its insolubility in the aqueous electrolyte solution, but also has high affinity to water and charge-carrying ions such as H₃O⁺ or Cl⁻ due to the hydrophilicity and ionomeric property of the polymer and therefore high ionic conductivity and low membrane specific area resistance.

The hydrophilic ionomeric polymer coating layer on the ionically conductive TFC membrane comprises a dense layer with a thickness typically in the range of about 1 micrometer to about 100 micrometers, or in the range of about 5 micrometers to about 50 micrometers. The dense hydrophilic ionomeric polymer coating layer forms very small nanopores with a pore size less than 0.5 nm in the presence of liquid water or water vapor, and in some cases combined with the existence of a cross-linked polymer structure via the complexing agent to control the swelling degree of the polymer, this results in high selectivity of charge-carrying ions such as protons, hydrated protons, chloride ions, potassium ions, hydrated potassium ions, sodium ions, and hydrated sodium ions over the electrolytes such as ferric ions, hydrated ferric ions, ferrous ions, and hydrated ferrous ions.

Suitable hydrophilic ionomeric polymers include, but are not limited to, a polyphosphoric acid-complexed polysaccharide polymer, a polyphosphoric acid and metal ion-complexed polysaccharide polymer, a metal ion-complexed polysaccharide polymer, a boric acid-complexed polysaccharide polymer, an alginate polymer such as sodium alginate, potassium alginate, calcium alginate, ammonium alginate, an alginic acid polymer, a hyaluronic acid polymer, a boric acid-complexed polyvinyl alcohol polymer, polyphosphoric acid-complexed polyvinyl alcohol polymer, a polyphosphoric acid and metal ion-complexed polyvinyl alcohol polymer, a metal ion-complexed polyvinyl alcohol polymer, a metal ion-complexed poly(acrylic acid) polymer, a boric acid-complexed poly(acrylic acid) polymer, a metal ion-complexed poly(methacrylic acid), a boric acid-complexed poly(methacrylic acid), or combinations thereof.

Various types of polysaccharide polymers may be used, including, but not limited to, chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof.

In some embodiments, the hydrophilic ionomeric polymer is a polyphosphoric acid-complexed chitosan polymer, a polyphosphoric acid and metal ion-complexed chitosan polymer, a metal ion-complexed alginic acid polymer, or combinations thereof.

In some embodiments, the hydrophilic ionomeric polymer is a boric acid-complexed polyvinyl alcohol polymer, a boric acid-complexed alginic acid, or a blend of boric acid-complexed polyvinyl alcohol and alginic acid polymer.

In some embodiments, the metal ion complexing agent is ferric ion, ferrous ion, or vanadium ion.

The microporous support membrane should have good thermal stability (stable up to at least 100° C.), high aqueous and organic solution resistance (insoluble in aqueous and organic solutions) under low pH condition (e.g., pH less than 6), high resistance to oxidizing and reducing conditions (insoluble and no performance drop under oxidizing and reducing conditions), high mechanical strength (no dimensional change under the system operation conditions), as well as other factors dictated by the operating conditions for energy storage applications. The microporous support membrane must be compatible with the cell chemistry and meet the mechanical demands of cell stacking or winding assembly operations. The microporous support membrane has high ionic conductivity but low selectivity of charge-carrying ions such as protons, hydrated protons, chloride ions, potassium ions, hydrated potassium ions, sodium ions, and hydrated sodium ions over the electrolytes such as ferric ions, hydrated ferric ions, ferrous ions, and hydrated ferrous ions.

The polymers suitable for the preparation of the microporous support membrane can be selected from, but not limited to, polyolefins such as polyethylene and polypropylene, polyamide such as Nylon 6 and Nylon 6,6, polyacrylonitrile, polyethersulfone, sulfonated polyethersulfone, polysulfone, sulfonated polysulfone, poly(ether ether ketone), sulfonated poly(ether ether ketone), polyester, cellulose acetate, cellulose triacetate, polybenzimidazole, polyimide, polyvinylidene fluoride, polycarbonate, cellulose, or combinations thereof. These polymers provide a range of properties such as low cost, high stability in water and electrolytes under a wide range of pH, good mechanical stability, and ease of processability for membrane fabrication.

The microporous support membrane can have either a symmetric porous structure or an asymmetric porous structure. The asymmetric microporous support membrane can be formed by a phase inversion membrane fabrication approach followed by direct air drying, or by phase inversion followed by solvent exchange methods. The microporous support membrane also can be fabricated via a dry processing of thermoplastic polyolefins or a wet processing of thermoplastic olefins. The dry processing of thermoplastic polyolefins utilizes extrusion to bring the polymer above its melting point and form it into the desired shape. Subsequent annealing and stretching processes may also be done to increase the crystallinity and orientation and dimension of the micropores. The wet processing of polyolefin separators is done with the aid of a hydrocarbon liquid or low molecular weight oil mixed with the polymer resin or a mixture of the polymer resin and inorganic nanoparticles in the melt phase. The melt mixture is extruded through a die similar to the dry processed separators. The thickness of the microporous support membrane can be in a range of 10-1000 micrometers, or a range of 10-900 micrometers, or a range of 10-800 micrometers, or a range of 10-700 micrometers, or a range of 10-600 micrometers, or a range of 10-500 micrometers, or a range of 20-500 micrometers. The pore size of the microporous membrane can be in a range of 10 nanometers to 50 micrometers, or a range of 50 nanometers to 10 micrometers, or a range of 0.2 micrometers to 1 micrometer.

Another aspect of the invention are methods of making the TFC membrane. In one embodiment, the method comprises applying a layer of an aqueous solution comprising a hydrophilic polymer to one surface of a microporous support membrane; drying the coated membrane; and optionally complexing the hydrophilic ionomeric polymer using a complexing agent to form a cross-linked hydrophilic ionomeric polymer.

In some embodiments, the coated membrane is dried before complexing the hydrophilic ionomeric polymer. In other embodiments, the coated membrane is dried after complexing the hydrophilic polymer. In other embodiments, the coated membrane is dried before complexing the hydrophilic ionomeric polymer and is dried again after complexing the hydrophilic polymer. The coated membrane may be dried for a time in a range of 5 min to 5 h, or 5 min to 4 h, or 5 min to 3 h, or 10 min to 2 h, or 30 min to 1 hat a temperature in a range of 40° C. to 100° C., or 40° C. to 80° C., or 55° C. to 65° C.

In some embodiments, the complexing agent is selected from polyphosphoric acid, boric acid, a metal ion, or combinations thereof.

In some embodiments, the metal ion is ferric ion, ferrous ion, or vanadium ion.

In some embodiments, the aqueous solution comprises acetic acid or other inorganic or organic acids.

In some embodiments, the hydrophilic ionomeric polymer on the coated membrane is treated in a second aqueous solution of hydrochloric acid before complexing the hydrophilic polymer.

In some embodiments, the hydrophilic polymer layer on the coated membrane is immersed in a second aqueous solution of polyphosphoric acid, boric acid, metal salt, hydrochloric acid, or combinations thereof.

In some embodiments, the hydrophilic polymer layer on the coated membrane is immersed in a second aqueous solution of polyphosphoric acid or boric acid for a time in a range of 5 min to 24 h, or 5 min to 12 h, or 5 min to 8 h, or 10 min to 5 h, or 30 min to 1 h, and then immersed in an aqueous metal salt or hydrochloric acid solution for a time in a range of 5 min to 24 h, or 5 min to 12 h, or 5 min to 8 h, or 10 min to 5 h, or 30 min to 1 h.

In other embodiments, the hydrophilic polymer is complexed in situ with a complexing agent in a negative electrolyte, a positive electrolyte, or both the negative electrolyte and the positive electrolyte in a redox flow battery cell.

In some embodiments, the hydrophilic ionomeric polymer comprises a polysaccharide polymer, a poly(acrylic acid) polymer, a poly(methacrylic acid), or combinations thereof.

In some embodiments, the polysaccharide polymer comprises chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof.

Another aspect of the invention is a redox flow battery system. In one embodiments, the redox flow battery system comprises: at least one rechargeable cell comprising a positive electrolyte, a negative electrolyte, and an ionically conductive thin film composite (TFC) membrane positioned between the positive electrolyte and the negative electrolyte, wherein the TFC membrane comprises a microporous support membrane and a hydrophilic ionomeric polymer coating layer on a surface of the microporous support membrane, wherein the hydrophilic ionomeric polymer coating layer is ionically conductive.

In some embodiment, the negative electrolyte, the positive electrolyte, or both the negative electrolyte and the positive electrolyte comprises a boric acid additive capable of complexing with a hydrophilic polymer on the surface of the microporous support membrane to form a cross-linked hydrophilic ionomeric polymer coating layer.

In some embodiment, the negative electrolyte, the positive electrolyte, or both the negative electrolyte and the positive electrolyte comprises ferrous chloride.

In some embodiment, the positive electrolyte comprises ferrous chloride and hydrochloric acid.

In some embodiments, the hydrophilic ionomeric polymer coating layer is formed in situ by complexing a hydrophilic polymer on the surface of the microporous support membrane with a complexing agent in the negative electrolyte, the positive electrolyte, or both the negative electrolyte and the positive electrolyte.

### EXAMPLES

### Comparative Example 1

### Preparation of Chitosan/Daramic® TFC Membrane

A 6.5 wt % chitosan aqueous solution was prepared by dissolving chitosan polymer in a 2 wt % acetic acid aqueous solution. One surface of a Daramic® microporous support membrane purchased from Daramic, LLC was coated with a thin layer of the 6.5 wt % chitosan aqueous solution and dried at 60° C. for 12 h in an oven to form a thin, nonporous, chitosan layer with a thickness of about 30 micrometers on the surface of the Daramic® support membrane. The coated membrane was treated with a basic sodium hydroxide solution, and washed with water to form a thin, nonporous, chitosan layer with a thickness of about 30 micrometers on the surface of the Daramic® support membrane.

### Comparative Example 2

### Preparation of Polyvinyl Alcohol (PVA)/Daramic® TFC Membrane

A 10.0 wt % polyvinyl alcohol (PVA) aqueous solution was prepared by dissolving PVA polymer with an average M_{w} of 130,000 in deionized (DI) water. One surface of a Daramic® microporous support membrane purchased from Daramic, LLC was coated with a thin layer of the 10.0 wt % PVA aqueous solution and dried at 60° C. for 12 h in an oven to form a thin, nonporous, PVA layer with a thickness of about 30 micrometers on the surface of the Daramic® support membrane.

### Example 1

### Preparation of Polyphosphous Acid (PPA) and Ferric Ion (Fe³⁺) Complexed Chitosan/Daramic® TFC Membrane (Abbreviated as PPA-Fe-Chitosan/Daramic®)

A 6.5 wt % chitosan aqueous solution was prepared by dissolving chitosan polymer in a 2 wt % acetic acid aqueous solution. One surface of a Daramic® microporous support membrane purchased from Daramic, LLC was coated with a thin layer of the 6.5 wt % chitosan aqueous solution and dried at 60° C. for 2 h in an oven to form a thin, nonporous, chitosan layer with a thickness of about 30 micrometers on the surface of the Daramic® support membrane. The coated membrane was treated with a 10.0 wt % PPA aqueous solution for 30 min, rinsed with DI water, then treated with a 1.5 M FeCl₃ aqueous solution for another 30 min, and finally rinsed with DI water to form PPA-Fe-Chitosan/Daramic® TFC membrane.

### Example 2

### Preparation of Boric Acid (BA) Complexed Polyvinyl Alcohol (PVA)/Daramic® TFC Membrane (Abbreviated as BA-PVA/Daramic®)

A 10.0 wt % polyvinyl alcohol (PVA) aqueous solution was prepared by dissolving PVA polymer with an average M_{w} of 130,000 in DI water. One surface of a Daramic® microporous support membrane purchased from Daramic, LLC was coated with a thin layer of the 10.0 wt % PVA aqueous solution and dried at 60° C. for 2 h in an oven to form a thin, nonporous, PVA layer with a thickness of about 30 micrometers on the surface of the Daramic® support membrane. The dried TFC membrane was treated with a 0.5 M boric acid aqueous solution for 30 min and dried at 60° C. for 1 h to form the dried BA-PVA/Daramic® TFC membrane.

### Example 3

### Preparation of Ferric Ion (Fe³⁺) Complexed Alginic Acid (AA)/Daramic® TFC Membrane (Abbreviated as Fe-AA/Daramic®)

A 8.0 wt % sodium alginate aqueous solution was prepared by dissolving sodium alginate polymer in DI water. One surface of a Daramic® microporous support membrane purchased from Daramic, LLC was coated with a thin layer of the 8.0 wt % sodium alginate aqueous solution and dried at 60° C. for 2 h in an oven to form a thin, nonporous, sodium alginate layer with a thickness of about 30 micrometers on the surface of the Daramic® support membrane. The dried TFC membrane was treated with a 1.0 M hydrochloric acid aqueous solution for 30 min to convert sodium alginate coating layer to alginic acid coating layer, then treated with a 1.5 M FeCl₃ aqueous solution for another 30 min, and finally dried at 60° C. for 1 h to form the dried Fe-AA/Daramic® TFC membrane.

### Example 4

### Preparation of Boric Acid Complexed Alginic Acid (AA) and PVA Blend Polymer/Daramic® TFC Membrane (Abbreviated as BA-AA-PVA/Daramic®)

An aqueous solution comprising 6.0 wt % of PVA and 4 wt % of sodium alginate was prepared by dissolving sodium alginate and PVA polymers in DI water. One surface of a Daramic® microporous support membrane purchased from Daramic, LLC was coated with a thin layer of the aqueous solution comprising 6.0 wt % of PVA and 4 wt % of sodium alginate and dried at 60° C. for 2 h in an oven to form a thin, nonporous, sodium alginate/PVA blend polymer layer with a thickness of about 30 micrometers on the surface of the Daramic® support membrane. The dried TFC membrane was treated with a 1.0 M hydrochloric acid aqueous solution for 30 min, then treated with a 0.5 M boric acid aqueous solution for another 30 min, and finally dried at 60° C. for 1 h to form the dried BA-AA-PVA/Daramic® TFC membrane.

### Example 5

### Preparation of Boric Acid Complexed Alginic Acid (AA)/Daramic® TFC Membrane (Abbreviated as BA-AA/Daramic®)

A 8.0 wt % sodium alginate aqueous solution was prepared by dissolving sodium alginate polymer in DI water. One surface of a Daramic® microporous support membrane purchased from Daramic, LLC was coated with a thin layer of the 8.0 wt % sodium alginate aqueous solution and dried at 60° C. for 2 h in an oven to form a thin, nonporous, sodium alginate layer with a thickness of about 30 micrometers on the surface of the Daramic® support membrane. The dried TFC membrane was treated with a 1.0 M hydrochloric acid aqueous solution for 30 min to convert sodium alginate coating layer to alginic acid coating layer. The alginic acid coating layer on the TFC membrane was complexed with boric acid in-situ during the IFB performance study in a BCS-810 battery cycling system (Biologic, FRANCE) comprising boric acid additive in the negative electrolyte solution.

### Example 6

### Preparation of Alginic Acid (AA)/Daramic® TFC Membrane (Abbreviated as AA/Daramic®)

A 8.0 wt % sodium alginate aqueous solution was prepared by dissolving sodium alginate polymer in DI water. One surface of a Daramic® microporous support membrane purchased from Daramic, LLC was coated with a thin layer of the 8.0 wt % sodium alginate aqueous solution and dried at 60° C. for 2 h in an oven to form a thin, nonporous, sodium alginate layer with a thickness of about 30 micrometers on the surface of the Daramic® support membrane. The dried TFC membrane was treated with a 1.0 M hydrochloric acid aqueous solution for 30 min to convert sodium alginate coating layer to alginic acid coating layer.

### Example 7

### Ferric Ion Crossover Study on Various Membranes

The low cost high performance hydrophilic ionomeric polymer coated TFC membranes are suitable for RFB applications. To compare the battery performance of these new membranes with the commercially available membranes, electrochemical impedance spectroscopy (EIS) was used to measure the ionic conductivity, the numbers of battery charge/discharge cycles, VE, CE, and EE of a IFB cell and the electrolyte crossover through the membranes were also measured.

Ferric ion crossover studies on a commercially available perfluorosulfonic acid (PFSA)-based Nafion® 117 cation exchange membrane, a microporous Daramic® membrane, the Chitosan/Daramic® TFC membrane prepared in Comparative Example 1, the PVA/Daramic® TFC membrane prepared in Comparative Example 2, the PPA-Fe-Chitosan/Daramic® TFC membrane prepared in Example 1, the BA-PVA/Daramic® TFC membrane prepared in Example 2, the Fe-AA/Daramic® TFC membrane prepared in Example 3, and the BA-AA-PVA/Daramic® TFC membrane prepared in Example 4 were conducted. The ferric ion crossover studies were conducted using a H-cell comprising two chambers with one chamber filled with 1.5 M FeCl₂ and the other chamber filled with 1.5 M FeCl₃. The concentration of Fe³⁺ in the 1.5 M FeCl₂ chamber was measured using DR6000 UV-vis (HACH, US) over time at room temperature. The Fe³⁺ crossover was calculated based on the slope of Fe³⁺ concentration vs time and the results were summarized in Table 1.

It can be seen from Table 1 that the Nafion® 117 membrane showed much lower Fe³⁺ crossover than the microporous Daramic® membrane, suggesting that the Nafion® membrane will have higher proton/Fe³⁺ selectivity and therefore higher CE in IFB than a Daramic® membrane. The Chitosan/Daramic® TFC membrane prepared in Comparative Example 1 and the PVA/Daramic® TFC membrane prepared in Comparative Example 2 showed lower Fe³⁺ crossover than the microporous Daramic® membrane due to the incorporation of a chitosan or PVA layer on Daramic® membrane. All of the new membranes including PPA-Fe-Chitosan/Daramic® TFC membrane prepared in Example 1, the BA-PVA/Daramic® TFC membrane prepared in Example 2, the Fe-AA/Daramic® TFC membrane prepared in Example 3 and the BA-AA-PVA/Daramic® TFC membrane prepared in Example 4 showed significantly reduced Fe³⁺ crossover compared to the microporous Daramic® support membrane and even lower than Nafion® 117 membrane. These results demonstrated that the hydrophilic ionomeric polymer coated TFC membranes exhibited desired low Fe³⁺ crossover for IFB applications and better crossover performance than commercially available membranes. The crossover performance was also better than the hydrophilic polymer coated TFC membranes without iononic functionality.

TABLE 1
Ferric Ion Crossover Study on Various Membranes

| Membrane | Fe³⁺ Crossover (mmol/h) |
|---|---|
| Daramic ® | 10.2 |
| Nafion ® 117 | 0.38 |
| Chitosan/Daramic ® | 5.5 |
| (Comparative Example 1) | |
| PVA/Daramic ® | 4.5 |
| (Comparative Example 2) | |
| PPA-Fe-Chitosan/ | 0.1 |
| Daramic ® (Example 1) | |
| BA-PVA/Daramic ® | 0.05 |
| (Example 2) | |
| Fe-AA/Daramic ® | 0.25 |
| (Example 3) | |
| BA-AA-PVA/Daramic ® | 0.15 |
| (Example 4) | |

### Example 8

### IFB Performance Study on Various Membranes

The ionic conductivity, number of battery charge/discharge cycles, VE, CE, and EE of the hydrophilic ionomeric polymer coated TFC membranes were measured using EIS with a BCS-810 battery cycling system (Biologic, FRANCE) at room temperature, and the results were shown in Table 2. It can be seen from Table 2 that all the new hydrophilic ionomeric polymer coated Daramic® TFC membranes showed lower area specific resistance, much longer battery cycles, and higher EE than the microporous Daramic® support membranes. These new membranes also showed much lower area specific resistance, longer battery cycles, and much higher EE than Nafion® 117 membrane. Furthermore, the new TFC membranes with hydrophilic ionomeric polymer coating layers having both hydrophilicity and ionomeric properties showed much longer battery cycles and higher EE than the corresponding TFC membranes with a hydrophilic non-ionomeric polymer coating layer. This demonstrates that the combination of the size-exclusion ion-conducting separation mechanism derived from the hydrophilic property of the polymer combined with the ion-exchange ion-conducting separation mechanism derived from the ionomeric property of the polymer in the new hydrophilic ionomeric polymer coated TFC membranes significantly improved the membrane performance compared to commercially available membranes with either a size-exclusion ion-conducting separation mechanism such as microporous membranes or an ion-exchange ion-conducting separation mechanism such as Nafion® membrane.

TABLE 2
IFB Performance Measurement on Various Membranes ^{a}

| | Area | | | | |
|---|---|---|---|---|---|
| | Specific | | | | |
| | Resistance | # | VE | CE | EE |
| Membrane | (Ω · cm²) | Cycles | (%) | (%) | (%) |
| Daramic ® | 3.5 | 10 | 69 | 70 | 48 |
| Nafion ® 117 | 6.25 | 28 | 51 | 81 | 41 |
| Chitosan/Daramic ® | 1.1 | 15 | 68 | 72 | 49 |
| (Comparative Example 1) | | | | | |
| PVA/Daramic ® | 1.4 | 17 | 67 | 73 | 49 |
| (Comparative Example 2) | | | | | |
| PPA-Fe-Chitosan/ | 3.4 | 31 | 60 | 84 | 50 |
| Daramic ® (Example 1) | | | | | |
| BA-PVA/Daramic ® | 2.6 | 34 | 65 | 83 | 54 |
| (Example 2) | | | | | |
| Fe-AA/Daramic ® | 1.55 | 34 | 66 | 85 | 56 |
| (Example 3) | | | | | |
| BA-AA-PVA/Daramic ® | 2.25 | 33 | 62 | 85 | 52 |
| (Example 4) | | | | | |
| BA-AA/Daramic ® | 1.38 | 36 | 67 | 88 | 59 |
| (Example 5) | | | | | |
| AA/Daramic ® | 1.25 | 38 | 67 | 93 | 62 |
| (Example 6) | | | | | |

^{a} Negative electrolyte solution: 1.5M FeCl₂, 2M KCl, 0.3M boric acid; positive electrolyte solution: 1.5M FeCl₂, 1.5M KCl, 0.3M ascorbic acid, 0.5M KOH; charge current density: 30 mA/cm²; charge time: 4 h; discharge current density: 30 mA/cm²; discharge time: 4 h; # of cycles were counted with ≥70% CE.

### Specific Embodiments

While the following is described in conjunction with specific embodiments, it will be understood that this description is intended to illustrate and not limit the scope of the preceding description and the appended claims.

A first embodiment of the invention is an ionically conductive thin film composite (TFC) membrane comprising a microporous support membrane; a hydrophilic ionomeric polymer coating layer on a surface of the microporous support membrane, the hydrophilic ionomeric polymer coating layer is ionically conductive. An embodiment of the invention is one, any or all of prior embodiments in this paragraph up through the first embodiment in this paragraph wherein the hydrophilic ionomeric polymer comprises a polyphosphoric acid-complexed polysaccharide polymer, a polyphosphoric acid and metal ion-complexed polysaccharide polymer, a metal ion-complexed polysaccharide polymer, a boric acid-complexed polysaccharide polymer, an alginate polymer such as sodium alginate, potassium alginate, calcium alginate, ammonium alginate, an alginic acid polymer, a hyaluronic acid polymer, a boric acid-complexed polyvinyl alcohol polymer, polyphosphoric acid-complexed polyvinyl alcohol polymer, a polyphosphoric acid and metal ion-complexed polyvinyl alcohol polymer, a metal ion-complexed polyvinyl alcohol polymer, a metal ion-complexed poly(acrylic acid) polymer, a boric acid-complexed poly(acrylic acid) polymer, a metal ion-complexed poly(methacrylic acid), a boric acid-complexed poly(methacrylic acid), or combinations thereof. An embodiment of the invention is one, any or all of prior embodiments in this paragraph up through the first embodiment in this paragraph wherein the polysaccharide polymer comprises chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof. An embodiment of the invention is one, any or all of prior embodiments in this paragraph up through the first embodiment in this paragraph wherein metal ion is ferric ion, ferrous ion, or vanadium ion. An embodiment of the invention is one, any or all of prior embodiments in this paragraph up through the first embodiment in this paragraph wherein the hydrophilic ionomeric polymer is a polyphosphoric acid-complexed chitosan polymer, a polyphosphoric acid and metal ion-complexed chitosan polymer, a metal ion-complexed alginic acid polymer, or combinations thereof. An embodiment of the invention is one, any or all of prior embodiments in this paragraph up through the first embodiment in this paragraph wherein the metal ion is ferric ion, ferrous ion, or vanadium ion. An embodiment of the invention is one, any or all of prior embodiments in this paragraph up through the first embodiment in this paragraph wherein the hydrophilic ionomeric polymer is a boric acid-complexed polyvinyl alcohol polymer, a boric acid-complexed alginic acid, or a blend of boric acid-complexed polyvinyl alcohol and alginic acid polymer. An embodiment of the invention is one, any or all of prior embodiments in this paragraph up through the first embodiment in this paragraph wherein the support membrane comprises polyethylene, polypropylene, polyamide, polyacrylonitrile, polyethersulfone, sulfonated polyethersulfone, polysulfone, sulfonated polysulfone, poly(ether ether ketone), sulfonated poly(ether ether ketone), polyester, cellulose acetate, cellulose triacetate, polyimide, polyvinylidene fluoride, polycarbonate, cellulose, or combinations thereof. An embodiment of the invention is one, any or all of prior embodiments in this paragraph up through the first embodiment in this paragraph wherein the hydrophilic ionomeric polymer is present in the micropores of the support membrane.

A second embodiment of the invention is a method of preparing an ionically conductive thin film composite (TFC) membrane comprising applying a layer of an aqueous solution comprising a hydrophilic polymer to one surface of a microporous support membrane; drying the coated membrane; and optionally complexing the hydrophilic polymer using a complexing agent to form a cross-linked hydrophilic ionomeric polymer. An embodiment of the invention is one, any or all of prior embodiments in this paragraph up through the second embodiment in this paragraph wherein the hydrophilic polymer on the coated membrane is dried before complexing the hydrophilic polymer. An embodiment of the invention is one, any or all of prior embodiments in this paragraph up through the second embodiment in this paragraph wherein the coated membrane is dried after complexing the hydrophilic polymer. An embodiment of the invention is one, any or all of prior embodiments in this paragraph up through the second embodiment in this paragraph wherein the complexing agent is selected from polyphosphoric acid, boric acid, a metal ion selected from ferric ion, ferrous ion, or vanadium ion, or combinations thereof. An embodiment of the invention is one, any or all of prior embodiments in this paragraph up through the second embodiment in this paragraph wherein complexing the hydrophilic polymer comprises immersing the dried coated membrane in a second aqueous solution of polyphosphoric acid, boric acid, metal salt, hydrochloric acid, or combinations thereof. An embodiment of the invention is one, any or all of prior embodiments in this paragraph up through the second embodiment in this paragraph wherein complexing the hydrophilic polymer comprises complexing the dried coated membrane with a complexing agent in situ in a redox flow battery cell. An embodiment of the invention is one, any or all of prior embodiments in this paragraph up through the second embodiment in this paragraph wherein the hydrophilic polymer comprises a polysaccharide polymer, a poly(acrylic acid) polymer, a poly(methacrylic acid), or combinations thereof. An embodiment of the invention is one, any or all of prior embodiments in this paragraph up through the second embodiment in this paragraph wherein the polysaccharide polymer comprises chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof.

A third embodiment of the invention is a redox flow battery system, comprising at least one rechargeable cell comprising a positive electrolyte, a negative electrolyte, and an ionically conductive thin film composite (TFC) membrane positioned between the positive electrolyte and the negative electrolyte, wherein the TFC membrane comprises a microporous support membrane and a hydrophilic ionomeric polymer coating layer on a surface of the microporous support membrane, wherein the hydrophilic ionomeric polymer coating layer is ionically conductive. An embodiment of the invention is one, any or all of prior embodiments in this paragraph up through the third embodiment in this paragraph wherein the negative electrolyte, the positive electrolyte, or both the negative electrolyte and the positive electrolyte comprises a boric acid additive capable of complexing with a hydrophilic polymer on the surface of the microporous support membrane to form the cross-linked hydrophilic polymer coating. An embodiment of the invention is one, any or all of prior embodiments in this paragraph up through the third embodiment in this paragraph wherein the hydrophilic ionomeric polymer coating layer is formed in situ by complexing a hydrophilic polymer on the surface of the microporous support membrane with a complexing agent in the negative electrolyte, the positive electrolyte, or both the negative electrolyte and the positive electrolyte.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. An ionically conductive thin film composite (TFC) membrane comprising:
a microporous support membrane;
a hydrophilic ionomeric polymer coating layer on a surface of the microporous support membrane, the hydrophilic ionomeric polymer coating layer is ionically conductive.

2. The TFC membrane of claim 1 wherein the hydrophilic ionomeric polymer comprises a polyphosphoric acid-complexed polysaccharide polymer, a polyphosphoric acid and metal ion-complexed polysaccharide polymer, a metal ion-complexed polysaccharide polymer, a boric acid-complexed polysaccharide polymer, an alginate polymer, an alginic acid polymer, a hyaluronic acid polymer, a boric acid-complexed polyvinyl alcohol polymer, polyphosphoric acid-complexed polyvinyl alcohol polymer, a polyphosphoric acid and metal ion-complexed polyvinyl alcohol polymer, a metal ion-complexed polyvinyl alcohol polymer, a metal ion-complexed poly(acrylic acid) polymer, a boric acid-complexed poly(acrylic acid) polymer, a metal ion-complexed poly(methacrylic acid), a boric acid-complexed poly(methacrylic acid), or combinations thereof.

3. The TFC membrane of claim 2 wherein the polysaccharide polymer comprises chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof.

4. The TFC membrane of claim 2 wherein metal ion is ferric ion, ferrous ion, or vanadium ion.

5. The TFC membrane of claim 1 wherein the hydrophilic ionomeric polymer is a polyphosphoric acid-complexed chitosan polymer, a polyphosphoric acid and metal ion-complexed chitosan polymer, a metal ion-complexed alginic acid polymer, a sodium alginate polymer, an alginic acid polymer, a hyaluronic acid polymer, or combinations thereof.

6. The TFC membrane of claim 5 wherein the metal ion is ferric ion, ferrous ion, or vanadium ion.

7. The TFC membrane of claim 1 wherein the hydrophilic ionomeric polymer is a boric acid-complexed polyvinyl alcohol polymer, a boric acid-complexed alginic acid, or a blend of boric acid-complexed polyvinyl alcohol and alginic acid polymer.

8. The TFC membrane of claim 1 wherein the support membrane comprises polyethylene, polypropylene, polyamide, polyacrylonitrile, polyethersulfone, sulfonated polyethersulfone, polysulfone, sulfonated polysulfone, poly(ether ether ketone), sulfonated poly(ether ether ketone), polyester, cellulose acetate, cellulose triacetate, polybenzimidazole, polyimide, polyvinylidene fluoride, polycarbonate, cellulose, or combinations thereof.

9. The TFC membrane of claim 1 wherein the hydrophilic ionomeric polymer is present in the micropores of the support membrane.

10. A method of preparing an ionically conductive thin film composite (TFC) membrane comprising:
applying a layer of an aqueous solution comprising a hydrophilic ionomeric polymer to one surface of a microporous support membrane;
drying the coated membrane; and optionally
complexing the hydrophilic ionomeric polymer using a complexing agent to form a cross-linked hydrophilic ionomeric polymer.

11. The method of claim 10 wherein the hydrophilic ionomeric polymer on the coated membrane is dried before complexing the hydrophilic ionomeric polymer.

12. The method of claim 10 wherein the coated membrane is dried after complexing the hydrophilic ionomeric polymer.

13. The method of claim 10 wherein the complexing agent is selected from polyphosphoric acid, boric acid, a metal ion selected from ferric ion, ferrous ion, or vanadium ion, or combinations thereof.

14. The method of claim 10 wherein complexing the hydrophilic ionomeric polymer comprises immersing the dried coated membrane in a second aqueous solution of polyphosphoric acid, boric acid, metal salt, hydrochloric acid, or combinations thereof.

15. The method of claim 10 wherein complexing the hydrophilic ionomeric polymer comprises complexing the dried coated membrane with a complexing agent in situ in a redox flow battery cell.

16. The method of claim 10 wherein the hydrophilic ionomeric polymer comprises a polysaccharide polymer, a poly(acrylic acid) polymer, a poly(methacrylic acid), or combinations thereof.

17. The method of claim 16 wherein the polysaccharide polymer comprises chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof.

18. A redox flow battery system, comprising:
at least one rechargeable cell comprising a positive electrolyte, a negative electrolyte, and an ionically conductive thin film composite (TFC) membrane positioned between the positive electrolyte and the negative electrolyte, the positive electrolyte in contact with a positive electrode, and the negative electrolyte in contact with a negative electrode, wherein the TFC membrane comprises a microporous support membrane and a hydrophilic ionomeric polymer coating layer on a surface of the microporous support membrane, wherein the hydrophilic ionomeric polymer coating layer is ionically conductive.

19. The redox flow battery system of claim 18 wherein the negative electrolyte, the positive electrolyte, or both the negative electrolyte and the positive electrolyte comprises a boric acid additive capable of complexing with a hydrophilic ionomeric polymer on the surface of the microporous support membrane to form a cross-linked hydrophilic ionomeric polymer coating layer.

20. The redox flow battery system of claim 18 wherein the hydrophilic ionomeric polymer coating layer is formed in situ by complexing a hydrophilic ionomeric polymer on the surface of the microporous support membrane with a complexing agent in the negative electrolyte, the positive electrolyte, or both the negative electrolyte and the positive electrolyte.
